(19) United States
(12) Patent Application Publication
(10) Pub. No.: US 2025/0307735 A1
(43) Pub. Date: Oct. 2, 2025

(54) Inspection Reliability Evaluation System

(71) Applicant: The Boeing Company, Arlington, VA (US)

(72) Inventor: Leanne Renee Jensen, Everett, WA (US)

(21) Appl. No.: 19/075,998

(22) Filed: Mar. 11, 2025

Related U.S. Application Data
(60) Provisional application No. 63/570,368, filed on Mar. 27, 2024.

(51) Int. Cl. G06Q 10/0631; G06F 9/451

(52) U.S. Cl. CPC G06Q 10/063114; G06F 9/451

(57) ABSTRACT

A method, system and computer program product for estimating reliability of a human inspection of a production system. Human inspection variables specific to the human inspection and the environment the inspection was conducted in are identified through human factors engineering research. The identified human inspection variables are weighted. Environment input or feedback about the inspection is received. The environment input received is also weighted. An assessment of the reliability of the human inspection is calculated using the human inspection variables and the received environment input.

### CROSS-REFERENCE TO RELATED APPLICATION

This application claims the benefit of U.S. Provisional Patent Application Ser. No. 63/570,368, filed Mar. 27, 2024, and entitled “Inspection Reliability Evaluation System,” which is incorporated herein by reference in its entirety.

### BACKGROUND INFORMATION

### 1. Field

The present disclosure relates generally to reliability of inspections of production systems and, in particular, to a method and system for estimating human error and reliability of human visual inspections of production systems.

### 2. Background

In designing and manufacturing parts, inspection of parts manufactured by production systems is essential to approach consistency, ensure safety, and increase efficiency and reduce cost of the manufacturing process. Human capability to detect anomalies and out of the ordinary conditions of manufactured parts is often over estimated, including when designing and executing processes. When inspecting aircraft parts, human capability for visual detection is limited and leads to potential quality and foreign object debris escapes. Overall, general detection rates for humans are estimated to be between 70%-80%, while in aerospace applications, humans are estimated to visually detect anomalies 68% of the time. Visual detection is impacted by numerous environmental factors affecting performance.

Historically, inspection efficiency for safety critical components in the aerospace industry has been over-estimated. Current solutions to estimating human error regarding inspection efficiency numbers are subjective, not well documented, and often based upon an individual's judgement. The individual providing the estimate rarely has a Human Factors Engineering background and is not familiar with the variables influencing human performance, leading to erroneous estimations. This can cause many issues based on the criticality of the system being inspected. Issues can range from underestimating escape rate, customer findings, and corrective action requests to certification issues and additional, more frequent, costly fleet inspections.

Publicly available tools are tailored to control room operators and do not include the dynamic, multi-variable environment found in production systems in the aerospace industry. The methods currently available to other industries do not provide accurate estimations of human error for production systems.

Therefore, it would be desirable to have a method and apparatus that take into account at least some of the issues discussed above, as well as other possible issues. For example, it would be desirable to have reliable, repeatable methods for use within aerospace, inspection, or production systems for estimating human error and reliability.

### SUMMARY

An embodiment of the present disclosure provides a method for estimating reliability of a human inspection of a production system. The method includes identifying a set of variables of the human inspection and assigning a weighting to each identified variable. The method further includes receiving input about the set of variables that is specific to the human inspection. An assessment of the reliability of the human inspection is calculated based on the received input.

Another embodiment of the present disclosure provides a system for human inspection reliability evaluation. The system comprises a computer system, a set of attributes, a set of performance shaping factors, and a set of weighted criteria. The set of attributes relate to a production system in an environment in which the human inspection is to be performed in. The set of performance shaping factors relate to each attribute. The set of weighted criteria are associated with each performance shaping factor. The computer system receives input relating to the performance shaping factors specific to the human inspection, calculates an assessment of the reliability of the human inspection using the set of weighted criteria, and displays results of the assessment including an overall assessment and an estimated range of success.

Yet another embodiment of the present disclosure provides a computer program product for estimating reliability of an inspection of a production system. The computer program product comprises a computer-readable storage media with first program code and second program code stored on the computer-readable storage media. The first program code is executable by a computer system to cause the computer system to collect input about a set of variables specific to the inspection. The second program code is executable by the computer system to cause the computer system to calculate an assessment of the reliability of the inspection based on the collected input.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a production system inspection environment in accordance with an illustrative embodiment;

FIG. 3 is an illustration of a table of a set of attributes, a set of PSF, and environment input in accordance with an illustrative embodiment;

FIG. 4 is an illustration of a sample attribute and associated performance shaping factors in accordance with an illustrative embodiment;

FIG. 5 is an illustration of a table of recommendations in accordance with an illustrative embodiment;

FIG. 6 is an illustration of a flowchart of a process for estimating reliability of a human inspection of a production system in accordance with an illustrative embodiment;

FIG. 7 is an illustration of a block diagram of a data processing system in accordance with an illustrative embodiment;

FIG. 8 is an illustration of an aircraft manufacturing and service method in accordance with an illustrative embodiment; and

FIG. 9 is an illustration of a block diagram of an aircraft in which an illustrative embodiment may be implemented.

### DETAILED DESCRIPTION

The illustrative embodiments recognize and take into account one or more different considerations. For example, the illustrative embodiments recognize and take into account that human visual inspection of parts, especially aerospace parts, and the ability to detect anomalies in manufactured parts is often overestimated resulting in potential manufacturing quality issues.

The illustrative embodiments recognize and take into account that typical current solutions to estimating human error regarding inspection efficiency numbers are subjective and often based upon an individual's judgement. Inspectors rarely have a Human Factors Engineering background and are not familiar with the variables influencing human performance which could lead to erroneous conclusions.

The illustrative embodiments recognize and take into account that current available tools do not account for the dynamic, multi-variable environment found in production systems in the aerospace industry and do not provide accurate estimations of human error for aerospace production systems.

Thus, the illustrative embodiments provide a method and system for estimating human error and reliability of human visual inspections of production systems based on the production system and the environment the inspection was performed in. The illustrative embodiments predict and minimize risk associated with human error in inspection of production systems taking into account how the environment the inspection was conducted in affects human judgment.

The illustrative embodiments provide a method of estimating human error and providing recommendations for areas of improvement. The illustrative example is a technological improvement over current solutions to estimating human error regarding inspection efficiency based upon an individual's judgement because the illustrative embodiments incorporate human engineering factors to identify and combine a set of variables across a set of categories related to risks in human inspection including task factors, time, stressors, experience and training, documentation, ergonomics, and culture.

As used herein, a “set of,” when used with reference to items, means one or more items. For example, a “set of variables” is one or more variables.

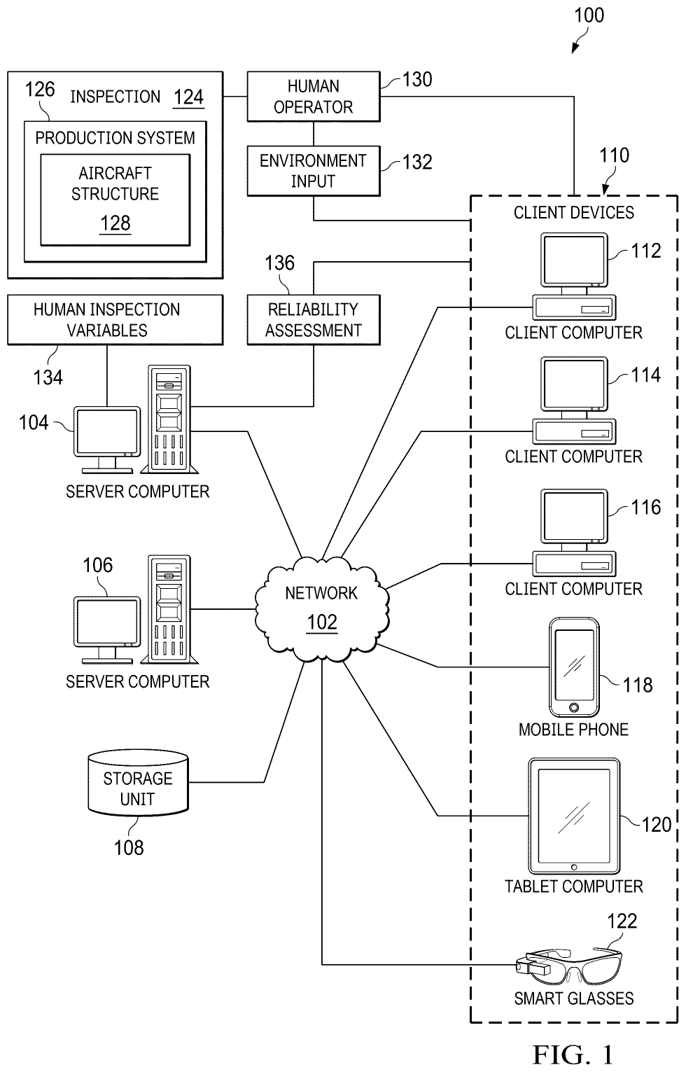

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet-of-things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, human operator 130 performs inspection 124 on production system 126. Human operator 130 may record inspection results in client devices 110. Inspection 124 involves, for example but is not limited to, visually searching for anomalies and out of the ordinary conditions of manufactured parts of production system 126. Production system 126 may involve production of parts for aircraft structure 128. Aircraft structure 128 can be, for example, a component or subcomponents for an aircraft. The component can be, for example, a wing or a fuselage section, and the subcomponent can be a stiffened skin panel, a sheer web, or some other suitable subcomponent.

In this illustrative example, environment input 132 is input into, for example, client computer 112. However, environment input 132 can be collected via any of the example client devices 110. Environment input 132 may be entered by human operator 130 that performed inspection 124 or may be entered by a third party. Environment input 132 is the answers to questions regarding human inspection variables 134. Environment input 132 includes weighted criteria associated with environmental factors of human operator 130 and the environment inspection 124 was conducted in.

In this illustrative example, human inspection variables 134 are predetermined human performance variables that may be tailored to a specific inspection 124. Human inspection variables 134 are in the form of questions inquiring about the environment human operator 130 was in when inspection 124 was performed. Human inspection variables 134 include a set of performance shaping features grouped into a set of attributes. The set of performance shaping features and the set of attributes include variables influencing human performance and may be tailored to the specific inspection 124 and production system 126. The set of attributes is weighted according to specifics of inspection 124 and production system 126. The weighting of human inspection variables 134 and the weighted environment input 132 factor in to the calculation of reliability assessment 136.

In this illustrative example, reliability assessment 136, based on environment input 132 and human inspection variables 134, provides an assessment of the reliability of inspection 124. Reliability assessment 136 may also provide recommendations for improvement for each variable of the set of variables.

In this illustrative example, human operator 130 or a third party interacts with human inspection variables 134 and inputs environment input 132 regarding the human influences of the environment that inspection 124 of production system 126 was performed in to generate reliability assessment 136. Reliability assessment 136 provides an assessment of the reliability of inspection 124 and recommendations for improvement. For example, reliability assessment 136 can include an approximate probability of success or detection ability of human operator 130 to detect anomalies in aircraft structure 128 and/or reliability assessment 136 can include an estimated range of success of human operator 130.

In addition, reliability assessment 136 can provide recommendations for areas of improvement regarding human inspection variables specific to inspection 124.

Reliability assessment 136 is important because reliability assessment 136 provides a realistic estimate of human efficiency, specifically the potential probability of success for a given process in real time. Historically, inspection efficiency for safety critical components has been over-estimated, resulting in additional inspections. Reliability assessment 136 provides a documented, quantitative method to validate human factors assumptions per Aircraft Certification, Safety, and Accountability Act (ACSAA). Reliability assessment 136 can be used to validate production processes and inspections, including verification and validation of inspection efficiency calculations. Reliability assessment 136 provides a standardized, reliable, and auditable method for estimating human error and reliability in the inspections of production systems in real time.

As depicted, client devices 110 send environment input 132 over network 102 to server computer 104, for example. Server computer 104 can use human inspection variables 134 and environment input 132 in server computer 104 to determine reliability assessment 136 for inspection 124 of production system 126. In other illustrative examples, human inspection variables 134 and environment input 132 can be located in the same computer or part of the same application or program.

Human operator 130 or a third party can repeat this process with another inspection of the same or another production system with human inspection variables 134 or another set of human inspection variables tailored to the next production system. Each reliability assessment 136 can be recorded and compared to improve the environment of future inspections to improve the probability of success or detection ability of the range of correct responses of future human inspections of production systems.

The use of reliability assessment 136 is a technological improvement as the number of inspections needed in a production cycle can be reduced greatly as compared to current techniques. Reduction of inspections is a practical application that contributes to faster production times and less costly manufacturing. In this manner, the time and expense of inspections can be reduced. Aircraft parts can be manufactured quicker with the assurance of more accurate and reliable inspections.

This process can be used for any type of structure in addition to or in place of aircraft structures. For example, this process can be used to inspect parts for manufacturing structures for use in other products such as a bridge, a vehicle, a building, or other products.

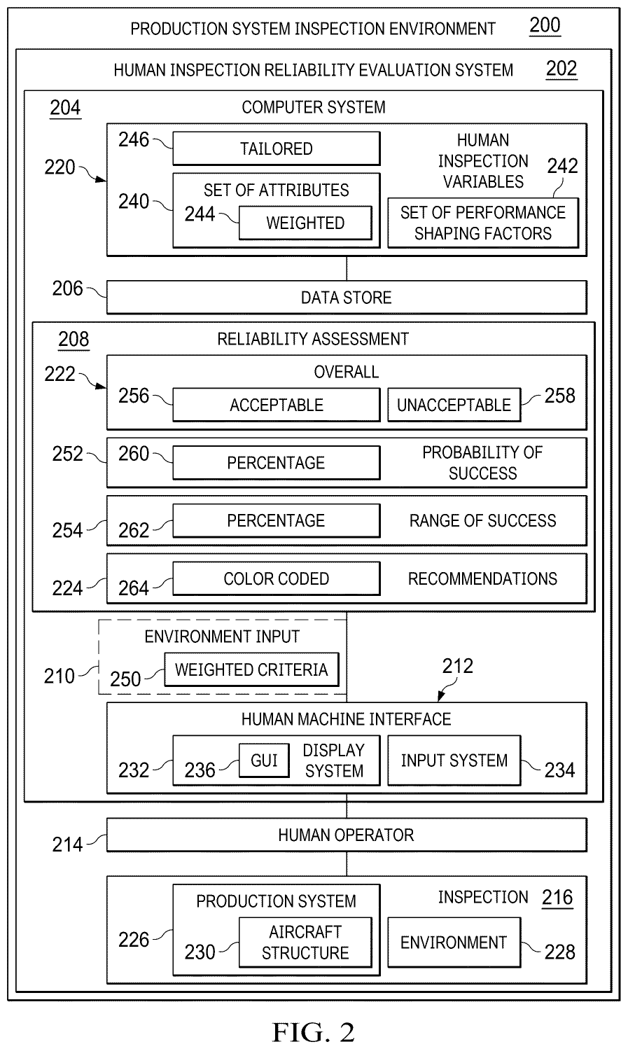

With reference now to FIG. 2, a block diagram of a production system inspection environment is depicted in accordance with an illustrative embodiment. In this illustrative example, production system inspection environment 200 includes components that can be implemented in hardware such as the hardware shown in network data processing system 100 in FIG. 1.

In this illustrative example, human inspection reliability evaluation system 202 can output reliability assessment 208 based on human inspection variables 220 and environment input 210. In other words, human inspection reliability evaluation system 202 can provide an overall 222 assessment of the reliability of inspection 216 and recommendations 224 for improvement while taking into account the environment 228 that inspection 216 was performed in.

In this illustrative example, human inspection reliability evaluation system 202 includes computer system 204 and human operator 214. Human operator 214 performs inspection 216 of production system 226 in environment 228. Production system 226 may be aircraft structure 230.

Aircraft structure 230 can take a number of different forms. Aircraft structure 230 can be selected from a group comprising a space-based structure, an aircraft, a commercial aircraft, a rotorcraft, a tilt-rotor aircraft, a tilt wing aircraft, a vertical takeoff and landing aircraft, a surface ship, a spacecraft, a space station, a satellite, a manufacturing facility, a chair, a passenger seat, an engine housing, a skin panel, a door, a fastener, a bolt, a spring, a seal, and other suitable types of products.

In this illustrative example, computer system 204 includes data store 206 and human machine interface 212. Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system. For example, computer system 204 can include one or more computers shown in network data processing system 100 in FIG. 1.

In this illustrative example, human operator 214 can interact with computer system 204 through human machine interface (HMI) 212. In this illustrative example, human machine interface 212 comprises display system 232 and input system 234.

Display system 232 is a physical hardware system and includes one or more display devices on which graphical user interface 236 can be displayed. The display devices can include at least one of a light emitting diode (LED) display, a liquid crystal display (LCD), an organic light emitting diode (OLED) display, a computer monitor, a projector, a flat panel display, a heads-up display (HUD) such as smart glasses 122 in FIG. 1, or some other suitable device that can output information for the visual presentation of information. Display system 232 can display reliability assessment 208.

As depicted, human operator 214 is a person that can interact with graphical user interface 236 by entering environment input 210 through input system 234 of computer system 204. Input system 234 is a physical hardware system and can be selected from at least one of a mouse, a keyboard, a trackball, a touchscreen, a stylus, a motion sensing input device, a gesture detection device, a cyber glove, or some other suitable type of input device.

In this illustrative example, human inspection variables 220 may be stored on data store 206. Data store 206 is a repository for storing collections of data such as set of attributes 240 and set of PSF 242. Data store 206 may be in a single location or may be distributed in multiple locations. Data store 206 may be located in at least one of a server computer, a storage system, a cloud computing platform, or in some other suitable storage construct.

Human inspection variables 220 include set of attributes 240 and set of performance shaping factors (PSF) 242. Set of attributes 240 are weighted 244. In other words, each attribute of set of attributes 240 contributes to the calculation of reliability assessment 208 according to their respective weighting. For example, each attribute of set of attributes 240 can be weighted 244 in the range of 0.1 to 5.0. It is important to note that each weighting of each attribute of set of attributes 240 is based on human factors engineering research. Each PSF of set of PSF 242 is grouped into at least one attribute of set of attributes 240. Set of attributes and set of PSF 242 are tailored 246 to a specific inspection 216 or a specific environment 228 or a specific production system 226 or any combination of the three based on human factors engineering research.

Human inspection variables 220 are hard-coded and stored within data store 206 and used to calculate reliability assessment 208. However, since human inspection variables 220 are tailored 246, they can be revised in response to any specific inspection 216 or environment 228 or production system 226 or aircraft structure 230.

In this illustrative example, computer system 204 can output reliability assessment 208 via display system 232 based on human inspection variables 220 and environment input 210. Environment input 210 are answers entered by human operator 214 or a third party in response to questions associated with human inspection variables 220. Environment input 210 includes weighted criteria 250. More specifically, human operator 214 or a third party familiar with inspection 216 and environment 228 that inspection 216 was performed in selects weighted criteria 250 as answers to questions presented in the form of set of PSF 242. Weighted criteria 250 may be presented to human operator 214 or a third party as a drop down list of answers, where each answer on the drop down list is weighted based on human factors engineering research.

In this illustrative example, reliability assessment 208 includes overall 222 assessment, probability of success 252, range of success 254, and recommendations 224. Overall 222 assessment includes whether the overall reliability of the inspection is acceptable 256 or unacceptable 258.

For example, reliability assessment 208 includes probability of success 252. In other words, probability of success 252 can be described as the ability of a human operator to detect anomalies in aircraft structure 230. The calculated probability of success 252, expressed as a percentage, represents the percentage of time the inspection results of a specific human inspector performing a specific inspection could be successful. A low percentage, for example, might include the misidentification of anomalies or the omission of an anomaly.

Reliability assessment 208 may also include estimated range of success 254 of human operator 214. In other words, estimated range of success 254 can be described as how accurate the calculated probability of success 252 may be.

Probability of success 252 and estimated range of success 254 are used to determine overall 222 assessment. Reliability assessment 208 can provide recommendations 224 for areas of improvement regarding human inspection variables 220 specific to inspection 216 based on weighted criteria 250 selected. Recommendations 224 are a function of reliability assessment 208 and human inspection variables 220. Each recommendation of recommendations 224 is color coded 264 where different colors represent different recommendations. For example, red indicates a PSF that needs attention, yellow indicates a PSF that should consider improvement, and green indicates a PSF where no action is needed. Each potential weighted criteria 250 is hard-coded to a specific recommendation outcome. In other words, recommendations 224 directly correspond to weighted criteria 250. Each weighted criteria 250 selected in response to each PSF of set of PSF 242 has a pre-determined recommendation which is color coded red, yellow, or green.

Reliability assessment 208 calculates probability of success 252 as percentage 260 using a success rate factor and a PSF calculation.

Where the success rate factor is 90% when the inspection is related to detection of anomalies in manufactured parts and where success rate factor is 99% when the inspection is related to assembly.

For example, when the inspection is related to assembly, probability of success 252 of reliability assessment 208 is represented by the following equation:

$$Probability of Success \% = ( 0.99 * Product of PSF / [ 0.99 * ( Product of SF - 1 ) + 1 ] \qquad Eq . \#1$$

The product of PSF calculation takes into account the set of attributes and the set of PSF and their associated weightings as well as the environment input and its associated weighting.

Reliability assessment 208 calculates range of success 254 as percentage 262.

Reliability assessment 208 calculates overall 222 assessment according to percentage 260 and percentage 262. If the calculated value of overall 222 assessment is equal to or exceeds a threshold, then overall 222 assessment of the reliability of the inspection is deemed acceptable 256. Otherwise, if the calculated value of overall 222 assessment does not reach the threshold, then overall 222 assessment of the reliability of the inspection is deemed unacceptable 258.

In the illustrative example, the use of reliability assessment 208 in computer system 204 integrates processes into a practical application for estimating human error and reliability of human visual inspections of production systems that increases the performance of computer system 204. In other words, reliability assessment 208 in computer system 204 is directed to a practical application of estimating reliability of a human inspection based on environment input 210 and human inspection variables 220, where the weighted 244 human inspection variables 220 and the weighted criteria 250 associated with environment input 210 is based on human factors engineering research.

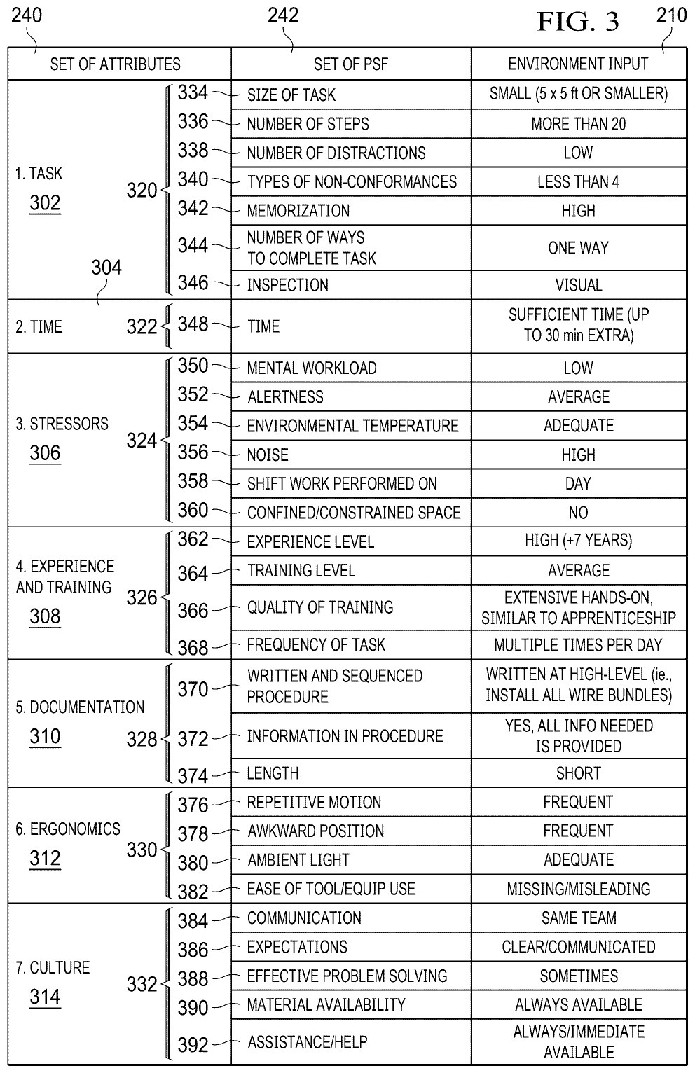

With reference next to FIG. 3, an illustration of a table of a set of attributes, a set of PSF, and environment input is depicted in accordance with an illustrative embodiment. In the illustrative examples, the same reference numeral may be used in more than one figure. This reuse of a reference numeral in different figures represents the same element in the different figures.

In this illustrative example, set of attributes 240 includes seven identified attributes. The seven identified attributes of set of attributes 240 in this illustrative example include task 302, time 304, stressors 306, experience and training 308, documentation 310, ergonomics 312, and culture 314. Although not shown, each attribute of set of attributes 240 is individually weighted. The weighting of each attribute contributes to reliability assessment 208 as described above.

In this illustrative example, set of PSF 242 includes thirty identified performance shaping factors. The thirty identified performance shaping factors of set of PSF 242 in this illustrative example are grouped by an attribute of set of attributes 240. Group 320, associated with task 302, includes size of task 334, number of steps 336, number of distractions 338, types of non-conformances 340, memorization 342, number of ways to complete task 341, and inspection 346. Group 322, associated with time 304, includes time 348. Group 324, associated with stressors 306, includes mental workload 350, alertness 352, environmental temperature 354, noise 356, shift work performed on 358, and confined/constrained space 360. Group 326, associated with experience and training 308, includes experience level 362, training level, 364, quality of training 366, and frequency of task 368. Group 328, associated with documentation 310, includes written and sequenced procedure 370, information in procedure 372, and length 374. Group 330, associated with ergonomics 312, includes repetitive motion 376, awkward position 378, ambient light 380, and ease of tool/equipment use 382. Group 332, associated with culture 314, includes communication 384, expectations 386, effective problem solving 388, material availability 390, and assistance/help 392.

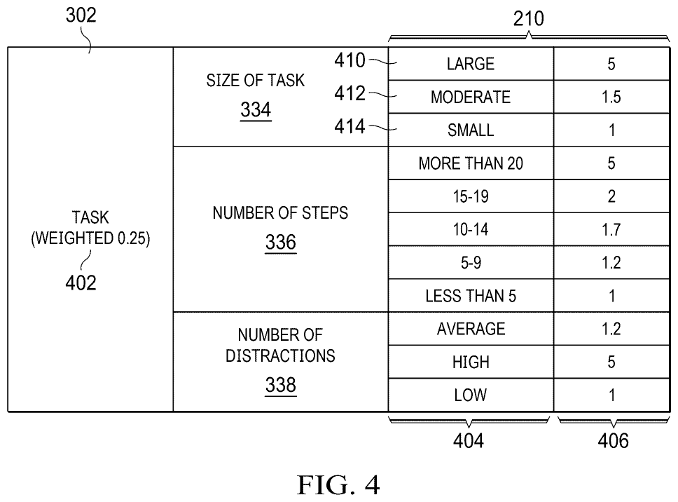

Depicted in the column for environment input 210 are examples of pre-programmed, weighted responses available to select for each PSF of set of PSF 242. Only one response for each PSF is depicted, however, it is understood that each PSF of set of PSF 242 will have a list of weighted answers available as environment input 210. The weighting of each response contributes to reliability assessment 208 as described above. The relationship of an attribute with a group of PSF of set of PSF 242 to environment input 210 is described below in FIG. 4.

It is important to note that the seven attributes and the thirty performance shaping factors depicted in this illustrative example have been determined through human factors engineering research and are specific to the particular inspection and production system being assessed, for example assembly or detection for an aircraft structure. The knowledge learned through human factors engineering research contributes to the technological improvement of the illustrative examples. It is possible that different attributes and different performance shaping factors or different combinations of attributes and performance shaping factors could be used for different inspection and production system scenarios.

With reference now to FIG. 4, an illustration of a sample attribute of set of attributes 240 and associated group of PSF of set of PSF 242 is depicted in accordance with an illustrative example. The table depicted in FIG. 4 illustrates a single attribute of set of attributes 240, for example, task 302. It is understood by those skilled in the art that each of the seven attributes of set of attributes 240 operates and contributes to reliability assessment 208 in a similar manner. In other words, each attribute of set of attributes 240 is associated with a group of PSF of set of PSF 242 which are further associated with unique weighted criteria. As depicted in FIG. 4, task 302, an attribute of set of attributes 240, has weighting 402. In this illustrative example, weighting 402 is “0.25”.

Performance shaping factors, for example, size of task 334, number of steps 336, and number of distractions 338 are associated with task 302. Depicted in the column for environmental input 210 are examples of weighted criteria 404. Weighted criteria 404 is an example of weighted criteria 250 shown in FIG. 2. Weighted criteria 404 are pre-programmed responses available regarding each PSF of set of PSF 242. It is important to note that each weighted criterion of weighted criteria 404 is weighted accordingly through human factors engineering research. Only one weighted criterion of weighted criteria 404 for each performance shaping factor can be selected. For example, in response to size of task 334, only large 410, moderate 412, and small 414 are available for selection. Each available weighted criterion of weighted criteria 404 has a unique weighting 406. For example, large 410 is weighted “5”, moderate 412 is weighted “1.5”, and small 414 is weighted “1”. Weighted criteria 404 may be presented to human operator 214 or a third party making the assessment, for example, as a drop-down list in graphical user interface 236 of display system 232.

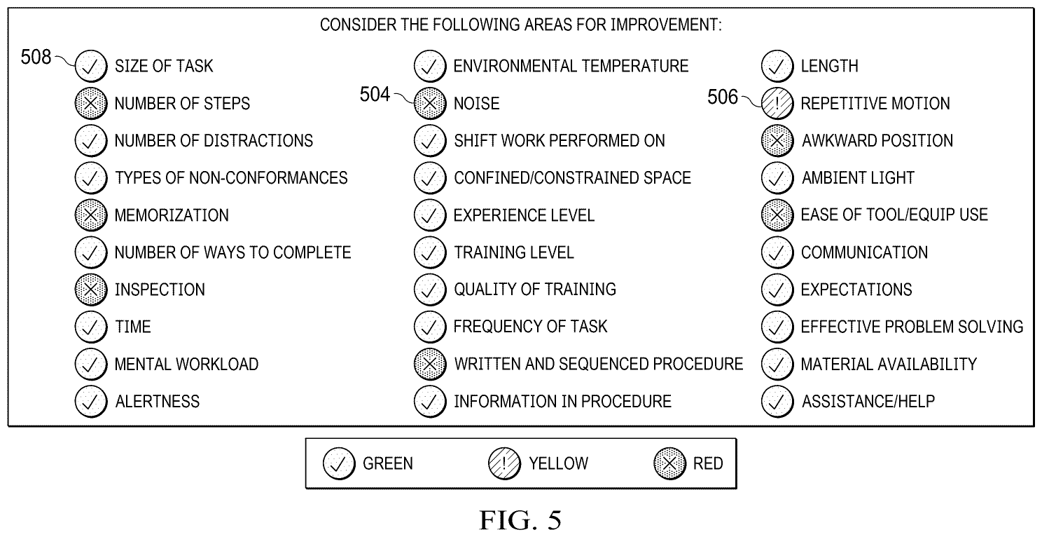

With reference now to FIG. 5, an illustration of a table of recommendations is depicted in accordance with an illustrative example. Reliability assessment 208 includes recommendations 502. Recommendations 502 is an example of recommendations 224 shown in FIG. 2. Reliability assessment 208 provides recommendations 502 which may identify areas of improvement with respect to each of the thirty PSF of set of PSF 242. Each recommendation of recommendations 502 is color coded. Each color is further tied to a particular symbol. Different colors, and their associated symbols, represent different recommendations. For example, a red “X”, depicted at 504, indicates a PSF that needs attention. A yellow exclamation mark, depicted at 506, indicates a PSF where improvement should be considered. A green checkmark, depicted at 508, indicates a PSF where no action is necessarily needed. Each potential criterion of weighted criteria 404 is hard-coded to a specific recommendation outcome. In other words, recommendations 502 directly correspond to weighted criteria 404. Each weighted criteria 404 selected in response to each PSF of set of PSF 242 has a pre-determined recommendation, either 504, 506, or 508, which is color coded red, yellow, or green, respectively.

Computer system 204 can be configured to perform at least one of the steps, operations, or actions described in the different illustrative examples using software, hardware, firmware, or a combination thereof. As a result, computer system 204 operates as a special purpose computer system in which weighted human inspection variables 220, determined through human factors engineering research, and weighted environment input 210 enables human inspection reliability evaluation in real time.

In the illustrative example, the use of human inspection variables in combination with environment input to produce a reliability assessment in computer system 204 integrates processes into a practical application for estimating reliability of a human inspection of a production system that increases the performance of computer system 204.

The illustrations of production system inspection environment 200 and the different components in this environment in FIGS. 2-5 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

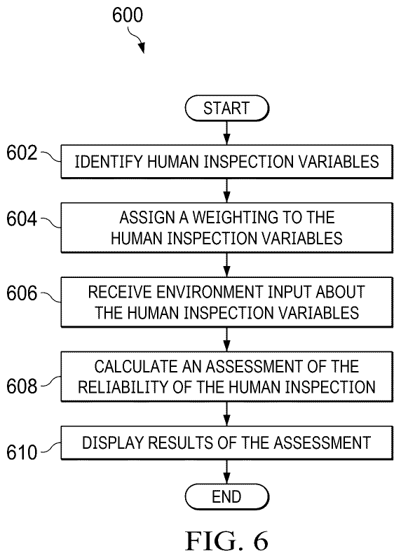

Turning next to FIG. 6, an illustration of a flowchart of a process for estimating reliability of a human inspection of a production system is depicted in accordance with an illustrative embodiment. The process in FIG. 6 can be implemented in hardware, software, or both. When implemented in software, the process can take the form of program code that is run by one or more processor units located in one or more hardware devices in one or more computer systems.

The process begins identifying human inspection variables (operation 602). The identified human inspection variables are specifically related to the human inspection performed. For example, the identified human inspection variables are specific to the type of inspection, such as, an assembly or anomaly detection. The identified human inspection variables are specific the environment the inspection is performed in. The human inspection variables are stored in data store 206 and can be revised according to each inspection scenario.

The process assigns a weighting to the human inspection variables (operation 604). Human inspection variables include attributes and performance shaping factors. Each attribute is individually weighted. At operation 606, the process, by a computer system, receives environment input about the human inspection variables. The environment input is entered into the computer system by the human inspector or a third party. The environment input is specific to the inspection performed and the environment the inspection was performed in. The environment input has weighted values.

At operation 608, the process calculates an assessment of the reliability of the human inspection. At operation 610, the results of the reliability assessment are displayed. The process terminates thereafter. As a result, the computer system, with weighted human inspection variables and weighted environment input determined through human factors engineering research, can estimate the reliability of a human inspection of a production system in real time resulting in minimizing the risk associated with human error in inspection of production systems and reducing the frequency of costly fleet inspections.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

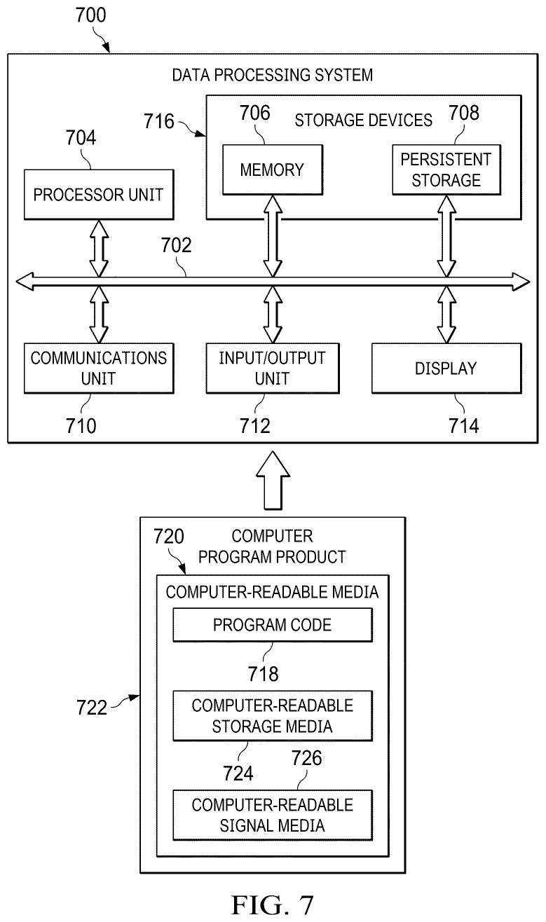

Turning now to FIG. 7, an illustration of a block diagram of a data processing system is depicted in accordance with an illustrative embodiment. Data processing system 700 can be used to implement server computer 104, server computer 106, client devices 110, in FIG. 1. Data processing system 700 can also be used to implement computer system 204 in FIG. 2. In this illustrative example, data processing system 700 includes communications framework 702, which provides communications between processor unit 704, memory 706, persistent storage 708, communications unit 710, input/output (I/O) unit 712, and display 714. In this example, communications framework 702 takes the form of a bus system.

Processor unit 704 serves to execute instructions for software that can be loaded into memory 706. Processor unit 704 includes one or more processors. For example, processor unit 704 can be selected from at least one of a multicore processor, a central processing unit (CPU), a graphics processing unit (GPU), a physics processing unit (PPU), a digital signal processor (DSP), a network processor, or some other suitable type of processor. Further, processor unit 704 can may be implemented using one or more heterogeneous processor systems in which a main processor is present with secondary processors on a single chip. As another illustrative example, processor unit 704 can be a symmetric multi-processor system containing multiple processors of the same type on a single chip.

Memory 706 and persistent storage 708 are examples of storage devices 716. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 716 may also be referred to as computer-readable storage devices in these illustrative examples. Memory 706, in these examples, can be, for example, a random-access memory or any other suitable volatile or non-volatile storage device. Persistent storage 708 can take various forms, depending on the particular implementation.

For example, persistent storage 708 may contain one or more components or devices. For example, persistent storage 708 can be a hard drive, a solid-state drive (SSD), a flash memory, a rewritable optical disk, a rewritable magnetic tape, or some combination of the above. The media used by persistent storage 708 also can be removable. For example, a removable hard drive can be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that can be connected to data processing system 700. For example, input/output unit 712 can provide a connection for user input through at least one of a keyboard, a mouse, or some other suitable input device. Further, input/output unit 712 can send output to a printer. Display 714 provides a mechanism to display information to a user.

Instructions for at least one of the operating system, applications, or programs can be located in storage devices 716, which are in communication with processor unit 704 through communications framework 702. The processes of the different embodiments can be performed by processor unit 704 using computer-implemented instructions, which can be located in a memory, such as memory 706.

These instructions are referred to as program code, computer usable program code, or computer-readable program code that can be read and executed by a processor in processor unit 704. The program code in the different embodiments can be embodied on different physical or computer-readable storage medium, such as memory 706 or persistent storage 708.

Program code 718 is located in a functional form on computer-readable media 720 that is selectively removable and can be loaded onto or transferred to data processing system 700 for execution by processor unit 704. Program code 718 and computer-readable media 720 form computer program product 722 in these illustrative examples. In the illustrative example, computer-readable media 720 is computer-readable storage media 724.

In these illustrative examples, computer-readable storage media 724 is a physical or tangible storage device used to store program code 718 rather than a medium that propagates or transmits program code 718. Computer readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 718 can be transferred to data processing system 700 using computer-readable signal media 726. Computer-readable signal media 726 can be, for example, a propagated data signal containing program code 718. For example, computer-readable signal media 726 can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 720” can be singular or plural. For example, program code 718 can be located in computer-readable media 720 in the form of a single storage device or system. In another example, program code 718 can be located in computer-readable media 720 that is distributed in multiple data processing systems. In other words, some instructions in program code 718 can be located in one data processing system while other instructions in program code 718 can be located in one data processing system. For example, a portion of program code 718 can be located in computer-readable media 720 in a server computer while another portion of program code 718 can be located in computer-readable media 720 located in a set of client computers.

The different components illustrated for data processing system 700 are not meant to provide architectural limitations to the manner in which different embodiments can be implemented. In some illustrative examples, one or more of the components may be incorporated in or otherwise form a portion of, another component. For example, memory 706, or portions thereof, can be incorporated in processor unit 704 in some illustrative examples. The different illustrative embodiments can be implemented in a data processing system including components in addition to or in place of those illustrated for data processing system 700. Other components shown in FIG. 7 can be varied from the illustrative examples shown. The different embodiments can be implemented using any hardware device or system capable of running program code 718.

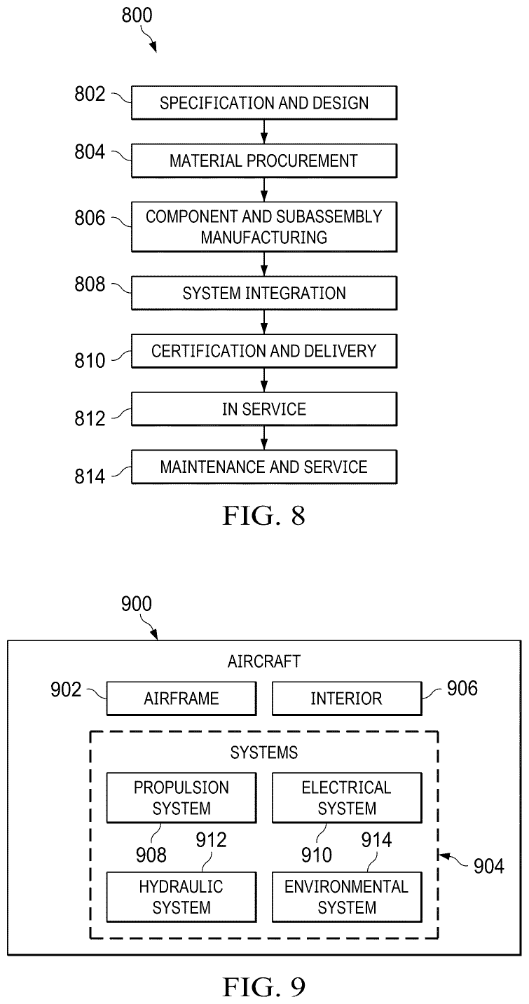

Illustrative embodiments of the disclosure may be described in the context of aircraft manufacturing and service method 800 as shown in FIG. 8 and aircraft 900 as shown in FIG. 9. Turning first to FIG. 8, an illustration of an aircraft manufacturing and service method is depicted in accordance with an illustrative embodiment. During pre-production, aircraft manufacturing and service method 800 may include specification and design 802 of aircraft 900 in FIG. 9 and material procurement 804.

During production, component and subassembly manufacturing 806 and system integration 808 of aircraft 900 in FIG. 9 takes place. Thereafter, aircraft 900 in FIG. 9 can go through certification and delivery 810 in order to be placed in service 812. While in service 812 by a customer, aircraft 900 in FIG. 9 is scheduled for routine maintenance and service 814, which may include modification, reconfiguration, refurbishment, and other maintenance or service.

Each of the processes of aircraft manufacturing and service method 800 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 9, an illustration of an aircraft is depicted in which an illustrative embodiment may be implemented. In this example, aircraft 900 is produced by aircraft manufacturing and service method 800 in FIG. 8 and may include airframe 902 with plurality of systems 904 and interior 906. Examples of systems 904 include one or more of propulsion system 908, electrical system 910, hydraulic system 912, and environmental system 914. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 800 in FIG. 8.

In one illustrative example, components or subassemblies produced in component and subassembly manufacturing 806 in FIG. 8 can be fabricated or manufactured in a manner similar to components or subassemblies produced while aircraft 900 is in service 812 in FIG. 8. As yet another example, one or more apparatus embodiments, method embodiments, or a combination thereof can be utilized during production stages, such as component and subassembly manufacturing 806 and system integration 808 in FIG. 8. One or more apparatus embodiments, method embodiments, or a combination thereof may be utilized while aircraft 900 is in service 812, during maintenance and service 814 in FIG. 8, or both. The use of a number of the different illustrative embodiments may substantially expedite the assembly of aircraft 900, reduce the cost of aircraft 900, or both expedite the assembly of aircraft 900 and reduce the cost of aircraft 900.

Operations in maintenance and service 814 include, for example, routine maintenance, inspections, upgrades, refurbishment, or other types of maintenance operations in which parts may be manufactured for use.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for estimating reliability of a human inspection of a production system, the method comprising:
identifying human inspection variables specific to the human inspection;
assigning a weighting to the human inspection variables;
receiving environment input about the human inspection variables, wherein the environment input is specific to the human inspection; and
calculating an assessment of the reliability of the human inspection based on the received environment input.

2. The method of claim 1, further comprising:
using a computer system to perform the steps of receiving the environment input about the human inspection variables and calculating the assessment of the reliability of the human inspection; and
wherein the computer system further performs the step of:
displaying results of the assessment.

3. The method of claim 2, wherein the computer system further performs the step of:
displaying results of the assessment, wherein the results displayed are color coded and each color indicates a status for each human inspection variable of no action needed, consider improvement, or needing attention.

4. The method of claim 2, wherein the computer system further performs the step of:
displaying results of the assessment, wherein the results displayed are an overall assessment of the reliability of the human inspection including acceptable or unacceptable based on a calculated probability of success and a calculated estimated range of success.

5. The method of claim 2, wherein the computer system further performs the step of:
displaying results of the assessment, wherein the results displayed include a calculated probability of success in the form of a first percentage and a calculated estimated range of success in the form of a second percentage.

6. The method of claim 2, wherein the receiving environment input about the human inspection variables is captured through use of a graphical user interface of the computer system.

7. The method of claim 1, wherein the human inspection variables comprise:
a set of attributes; and
a set of performance shaping factors related to each attribute of the set of attributes.

8. The method of claim 7, wherein each performance shaping factor of the set of performance shaping factors is associated with weighted criteria of the environment input.

9. The method of claim 1, wherein the environment input received about the human inspection variables comprises weighted criteria, the weighted criteria specific to the human inspection and an environment which the human inspection was performed in.

10. The method of claim 1, wherein the human inspection variables comprise:
a set of attributes;
a set of performance shaping factors related to each attribute of the set of attributes; and
wherein each performance shaping factor of the set of performance shaping factors is a question pertaining to a respective related attribute and an environment which the human inspection was performed in.

11. The method of claim 1, wherein the human inspection variables comprise:
a set of attributes;
a set of performance shaping factors related to each attribute of the set of attributes; and
weighted criteria of the environment input associated with each performance shaping factor of the set of performance shaping factors.

12. The method of claim 1, wherein the human inspection variables are tailored to the production system based on human factors engineering.

13. The method of claim 2, wherein the computer system further performs the step of:
providing recommendations for improvement for each human inspection variable based on the assessment.

14. A human inspection reliability evaluation system comprising:
a computer system;
a set of attributes relating to a production system and an environment in which a human inspection of the production system is to be performed in;
a set of performance shaping factors related to each attribute of the set of attributes;
weighted criteria of environment input, the weighted criteria related to each performance shaping factor of the set of performance shaping factors; and
wherein the computer system:
receives the environment input relating to the set of performance shaping factors specific to the human inspection;
calculates an assessment of the reliability of the human inspection using the weighted criteria associated with the environment input received relating to the set of performance shaping factors; and
displays results of the assessment, wherein the results displayed include an overall assessment of the reliability of the human inspection including acceptable or unacceptable based on a calculated probability of success and a calculated estimated range of success.

15. The system of claim 14, wherein the results displayed are color coded and each color indicates a status for each performance shaping factor of the set of performance shaping factors comprising one of no action needed, consider improvement, or needing attention.

16. A computer program product for estimating reliability of an inspection of a production system, the computer program product comprising:
a computer-readable storage media;
first program code, stored on the computer-readable storage media, executable by a computer system to cause the computer system to collect environment input about human inspection variables specific to the inspection, wherein the human inspection variables includes a weighting; and
second program code, stored on the computer-readable storage media, executable by the computer system to cause the computer system to calculate an assessment of the reliability of the inspection based on the collected environment input, wherein the assessment is used to provide recommendations for improvement for each human inspection variable.

17. The computer program product of claim 16 further comprising:
third program code, stored on the computer-readable storage media, executable by the computer system to display results of the assessment, wherein the results displayed are color coded and each color indicates a status for each human inspection variable of no action needed, consider improvement, or needing attention.

18. The computer program product of claim 16 further comprising:
third program code, stored on the computer-readable storage media, executable by the computer system to display results of the assessment, wherein the results displayed are an overall assessment of the reliability of the inspection including acceptable or unacceptable based on a calculated probability of success and a calculated estimated range of success.

19. The computer program product of claim 16 further comprising:
third program code, stored on the computer-readable storage media, executable by the computer system to display results of the assessment, wherein the results displayed include a calculated probability of success in the form of a first percentage and a calculated estimated range of success in the form of a second percentage.

20. The computer program product of claim 16 wherein, the first program code collects the environment input about the human inspection variables through use of a graphical user interface of the computer system.
